(19) United States
(12) Patent Application Publication
(10) Pub. No.: US 2015/0066919 A1
(43) Pub. Date: Mar. 5, 2015

(54) SYSTEMS AND METHODS FOR PROCESSING CROWD-SOURCED MULTIMEDIA ITEMS

(71) Applicant: ObjectVideo, Inc., Reston, VA (US)

(72) Inventors: Minwoo Park, Fairfax, VA (US); Tae Eun Choe, Reston, VA (US); W. Andrew Scanlon, Falls Church, VA (US); M. Allison Beach, Leesburg, VA (US); Gary W. Myers, Aldie, VA (US)

(21) Appl. No.: 14/470,848

(22) Filed: Aug. 27, 2014

Related U.S. Application Data
(60) Provisional application No. 61/870,402, filed on Aug. 27, 2013.

(51) Int. Cl. G06F 17/30

(52) U.S. Cl. CPC G06F 17/3005; G06F 17/30047
USPC 707/724; 707/722; 707/725

(57) ABSTRACT

Systems, methods, and computer applications and media for gathering, categorizing, sorting, managing, reviewing and organizing large quantities of multimedia items across space and time and using crowd-sourcing resources are described. Various implementations may enable either public or private (e.g., internal to an organization) crowdsourcing of multimedia item gathering and analysis, including the gathering, analysis, lead-searching, and classification of digital still images and digital videos. Various implementations may allow a user, such as a law enforcement investigator, to consolidate all of the available multimedia items into one system, and quickly gather, sort, organize, and display the multimedia items based on location, time, content, or other parameters. Moreover, an investigator may be able to create crowd source tasks as he works with the multimedia items and utilize crowd source resources when he needs help.

### CROSS-REFERENCE TO RELATED APPLICATIONS

This application is a non-provisional of and claims the benefit of U.S. Provisional Application No. 61/870,402 filed on 27 Aug. 2013, which is hereby incorporated by reference in its entirety.

### TECHNOLOGICAL FIELD

This disclosure relates generally to the field of automated gathering and processing of crowd-sourced multimedia items, and more particularly to generating, sorting, and presenting a relevant subset of multimedia items.

### BACKGROUND

In recent years, the amount of multimedia items and data in people's personal devices has grown dramatically and continues to grow at an ever increasing rate. The prevalence of smartphones, digital cameras, tablet computers, and the like has resulted in the digitization of all aspects of people's lives into multimedia items through digital voice, digital image, and digital video recordings and text. Although today's people are surrounded by a plethora of multimedia data of various kinds in various devices, the multimedia data exists in spatially and temporally discontinuous forms, which makes it difficult to organize and utilize.

When an event or emergency, such as the Boston Marathon bombings, occurs, law enforcement and the intelligence communities may be inundated with large quantities of multimedia items, especially visual media such as video recordings and still images. Currently, the best way to make visual multimedia items useful may be for an investigator to sit and watch videos and review images manually and personally, which is a very time-consuming process. Consequently, large quantities of potentially useful multimedia items may go unused due to lack of time and resources for review, especially for time-is-of-the-essence projects that require quick analysis, response, and action, such as public-safety emergencies or criminal events. Moreover, if useful multimedia items are identified, mechanisms do not exist to easily share that data with others and to easily and efficiently find related multimedia items.

Accordingly, it is desirable to develop innovations that address these drawbacks and improve upon current multimedia data gathering and analysis techniques and products.

### BRIEF DESCRIPTION OF THE DRAWINGS

The accompanying drawings, which are incorporated in and constitute a part of this specification, illustrate embodiments of the invention and together with the description, serve to explain the principles of the invention. In the figures:

FIG. 1 illustrates an example of a system for processing crowd-sourced multimedia items, consistent with the principles of this disclosure;

FIG. 2 is an example of a process for collecting multimedia items, consistent with the principles of this disclosure;

FIG. 3 shows an example of a graphical user interface (GUI) that may be provided by various implementations consistent with the principles of this disclosure;

FIG. 4 shows another example of a GUI that may be provided by various implementations consistent with the principles of this disclosure;

FIG. 5 is an example of a process for processing a plurality of multimedia items, consistent with the principles of this disclosure;

FIG. 6A is an example of a process for processing a multimedia item, consistent with the principles of this disclosure;

FIG. 6B is another example of a process for processing a multimedia item, consistent with the principles of this disclosure;

FIG. 7 shows an example of a GUI that may be provided by various implementations consistent with the principles of this disclosure; and

FIG. 8 is a block diagram of an example of a computing system that may be used to implement embodiments consistent with this disclosure.

### DETAILED DESCRIPTION

Reference will now be made in detail to various examples and embodiments of the invention, some of which are illustrated in the accompanying drawings. Wherever convenient, the same reference numbers will be used throughout the drawings to refer to the same or like parts.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program ode for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the users computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Various implementations consistent with the present disclosure include systems, methods, and computer applications and media for gathering, categorizing, sorting, managing, reviewing and organizing large quantities of multimedia items across space and time and using crowd-sourcing resources. Various implementations consistent with the present disclosure may enable either public or private (e.g., internal to an organization) crowdsourcing of information gathering and information analysis, including the gathering, analysis, lead-searching, and classification of multimedia items such as digital still images and digital videos. Various implementations consistent with the present disclosure may allow a user, such as a law enforcement investigator, to consolidate all available multimedia items into one place, and quickly gather, sort, organize, and display the multimedia items based on location, time, content, or other parameters. Moreover, an investigator may be able to create crowd source tasks as he works with the multimedia items and utilize crowd source resources when he needs help.

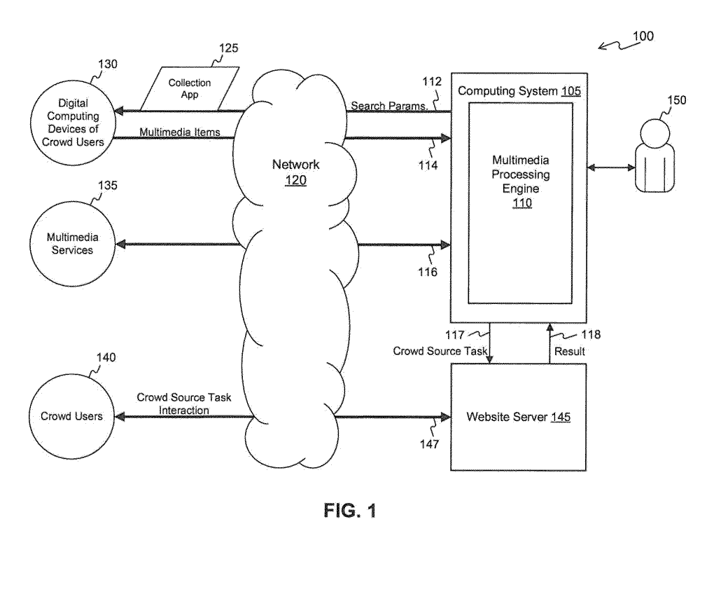

FIG. 1 illustrates an example of a system 100 for processing crowd-sourced multimedia items, consistent with the principles of this disclosure. In the example of an implementation shown in FIG. 1, system 100 includes a computing system 105 that includes or executes a multimedia processing engine 110, which performs operations and functions as described in this disclosure. In various implementations, the multimedia processing engine 110 may be implemented as a software application program that executes on the computing system 105, as firmware, as hardware, or as some combination of these.

The computing system 105 and the multimedia processing engine 110 communicate with various other entities 130-140 via a network 120. In various implementations, the network 120 may be closed or private local-area network, a public wide area network (e.g., the internet), a cellular telephone network, some combination of these, or some other type of communications network.

In various implementations, the computing system 105 and the multimedia processing engine 110 provide copies of a data collection application 125 to the digital computing devices 130 of a group of crowd users, as represented by arrow 112. In some embodiments, the multimedia processing engine 110 may load or allow the loading of the data collection application 125 to the digital computing devices 130. In some embodiments, the data collection application 125 may be provided to the digital computing devices 130 of a group of crowd users through an intermediary distributor (not shown), such as an appstore, download website, or the like. In such embodiments, the digital computing devices 130 may download the data collection application 125 from the intermediary, such as an Apple™ or Android™ appstore or the like, such that the supplier (e.g., computing system 105, the multimedia processing engine 110, or their controlling entity) indirectly provides the data collection application 125 to the digital computing devices 130 of a group of crowd users.

In various implementations, the data collection application 125 may be a software program or the like that executes on the digital computing devices 130 of a group of crowd users to collect or identify multimedia items from the devices, such as still image files, video files, audio files, or text files created or stored on the device, and to transmit the collected or identified multimedia items to the multimedia processing engine 110.

In the implementation shown, the data collection application 125 collects or identities multimedia items that have a close similarity to, match, or otherwise correspond to a set of search parameters that are provided to the data collection application 125 by the multimedia processing engine 110, as also represented by the arrow 112. Thus, the multimedia processing engine 110 can specify and periodically update or change the characteristics of the multimedia items that it wishes to receive or obtain from the digital computing devices 130 of the crowd users.

As represented by the arrow 114, the data collection application 125 executing on the digital computing devices 130 of the crowd users may transmit or otherwise provide multimedia items to the multimedia processing engine 110. As noted above, in the implementation shown, the digital computing devices 130 transmits multimedia items that correspond to the search parameters provided by the multimedia processing engine 110.

For example, consider a use case where 1000 digital computing devices 130 are running the data collection application 125, and the multimedia processing engine 110 provides (e.g., transmits) search parameters (arrow 112) specifying that it wishes to receive still images or videos taken on Apr. 15, 2013, in Boston, Mass., (which is the date and location of the Boston Marathon bombings). In response, the copy of the data collection application 125 running on each of the 1000 digital computing devices 130 searches its device for still image files and video files that are time-stamped Apr. 15, 2013 and that are location-stamped Boston, Mass. (e.g., having associated GPS coordinates corresponding to Boston). The data collection application 125 then transmits (arrow 114) copies of the relevant files (if any) to the multimedia processing engine 110.

As shown in FIG. 1, the computing system 105 and the multimedia processing engine 110 also communicate with multimedia sources 135 via the network 120. In various embodiments, the multimedia sources 135 may be websites, network-accessible image devices, or the like that provide access to multimedia items such as still image files, video files, audio files, or text files. Some examples include the Facebook™, Twitter™, Flickr™ and YouTube™ websites. Other examples of multimedia sources 135 include internet-accessible webcams, traffic cams, weather cams, and the like. As represented by two-headed arrow 116, the multimedia processing engine 110 may use an application programming interface (API) or other mechanism (e.g., a graphical user interface piloted by a human, such as an investigator 150) to identify or recognize relevant multimedia items available through the multimedia source 135 and download, transmit, or otherwise transfer the relevant multimedia items to the multimedia processing engine 110.

Yet another example of a multimedia source 135 is a crowd sourcing website or portal that solicits multimedia items from a public crowd. For instance, a website that allows a requestor (e.g., the investigator 150) to post a request for multimedia items created at specific time and location, allows crowd users to upload relevant multimedia items to the website in response, and allows the requestor to access (e.g., download) the crowd-provided multimedia items. An example of a request may be “Please upload any pictures or videos from the area around 700 Boylston Street, Boston, Mass. that were taken at any time on Apr. 15, 2013.”

In various implementations, the multimedia processing engine 110 gathers, filters, sorts, categorizes, manages, displays for review, and generally organizes the multimedia items received from the digital computing devices 130 of the crowd users and the multimedia sources 135. In various implementations, an investigator 150, such as a law enforcement agent, may interact with, direct, and otherwise utilize the multimedia processing engine 110 to perform various functions and achieve various goals as described in this disclosure. In some such implementations, the computing system 105 that executes the multimedia processing engine 110 may include input/output devices (not shown), such as a display device (e.g., an LCD monitor), keyboard and a mouse, which are used by the investigator 150 to interact with the multimedia processing engine 110.

In the implementation shown, the multimedia processing engine 110 may create a crowd source task (e.g., as specified by the investigator 150), and post or otherwise provide the crowd source task to a website server 145, as represented by arrow 117. Crowd users 140 may access and interact with the website server 145 via the network 120 to view and perform the crowd source task and thereby produce a result. The result may be transmitted by the website server 145 or otherwise obtained (arrow 118) by the multimedia processing engine 110, which may display the result to a user, such as the investigator 150.

For example, consider further the previous use case where the digital computing devices 130 and the multimedia sources 135 provide several thousand still images and videos taken on Apr. 15, 2013, in Boston, Mass. Because a single user such as the investigator 150 cannot personally review and analyze several thousand multimedia items in a timely manner, he may use the crowd users 140 to help review and analyze the multimedia items. For instance, if the investigator 150 had determined that a male wearing a white baseball cap was a person of interest, then he may create a crowd source task that requires the crowd users 140 to examine subsets of the multimedia items and appropriately tag those items that show a male wearing a white baseball cap. The website server 145 may display a subset of the multimedia items to each of the crowd users 140 and prompt the crowd user to indicate whether or not each item in the subset of multimedia items exhibits a male wearing a white baseball cap. The website server 145 may then return the result (arrow 118) to the multimedia processing engine 110 for use by the investigator 150. In various implementations, the result may include the multimedia items that were the subject of the crowd source task along with the tags added by the crowd users 140. In some implementations, the result may include the tags and information identifying the multimedia item that each is associated with, but not include the multimedia items themselves.

One of ordinary skill will recognize that the components, functions, and implementation details of system 100 are simplified examples presented for conciseness and clarity of explanation. Other components, functions, implementation details, and variations may be used. For example, the functions and operations of the computing system 105 and the website server 145 could be combined into a single computing system in a variant implementation. For another example, the investigator 150 could access and interact with the multimedia processing engine 110 via a separate computing system (e.g. a laptop computer) that communicates with the computing system 105 via the network 120. Many other variations are possible within the scope of this disclosure.

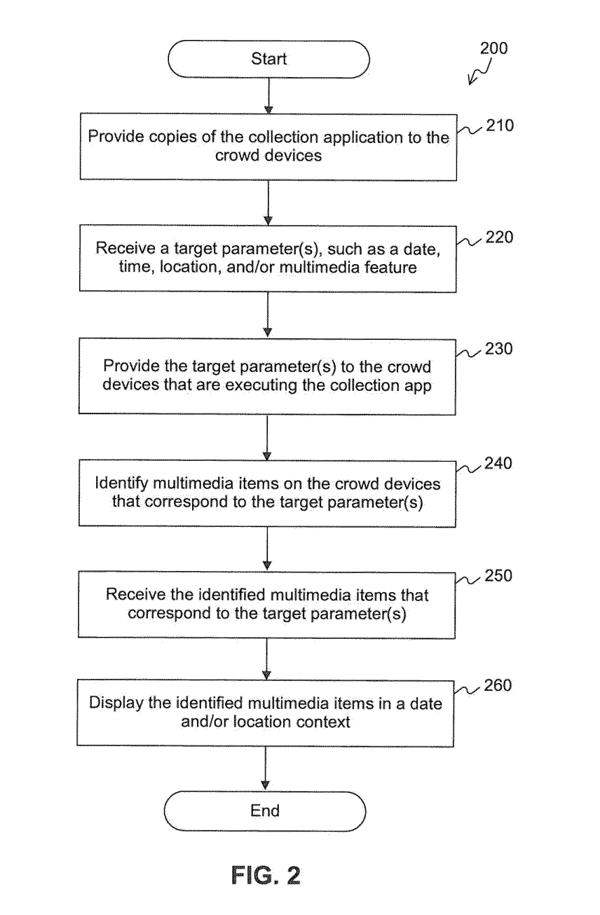

FIG. 2 is an example of a process 200 for collecting multimedia items, consistent with the principles of this disclosure. In some implementations, all or a portion of process 200 may be implemented in software (e.g., the multimedia processing engine 110 of FIG. 1) or firmware running on one or more computing systems, such as the computing system 105 of FIG. 1. As shown in FIG. 2, process 200 begins with providing copies of a data collection application 125 to crowd devices (stage 210). In various implementations, the data collection application 125 may be a software program that runs on a digital computing device or other computerized device, such as a smart phone, tablet computer, laptop computer, digital camera, digital audio recorder or the like. The computerized device may be owned or operated by a user that is part of a “crowd” that has volunteered, agreed, or otherwise been enabled to assist with supplying multimedia items, and that has installed the collection application 125 to execute on the computerized device. Various implementations of the data collection application 125 may function to search for recognize, select, or otherwise identify certain multimedia items stored on the computerized device. In some implementations, the data collection application 125 may filter, selectively search for or otherwise selectively identify only multimedia items on the computerized device that correspond to a specified characteristic(s).

At stage 220, process 200 receives one or more target search parameters. In various implementations, the target search parameters specify, define, or otherwise describe the specified characteristic(s) of the multimedia items to be collected from crowd users' devices. In some implementations, the target search parameter(s) may be received, for example, from the investigator 150 of FIG. 1, who may input the target search parameter(s) using a graphical user interface (GUI) not shown in FIG. 2) to the multimedia processing engine 110. In some implementations, the target search parameter(s) may also conic from sources other than the investigator 150, such as from an image recognition algorithm running on the multimedia processing engine 110, or from another computing system, etc.

In various implementations, the target search parameter(s) may specify a date, a date range, a time, a time range, a specific location, a geographic area, a feature of a multimedia item, a crowd definition, etc. Examples of a feature of a multimedia item include a visual feature that may appear in a still image or video, an audio feature, such as a word or sound, that may be heard in an audio recording or video, and one or more words or characters that may be contained in a text message or the text captured in a still image or video.

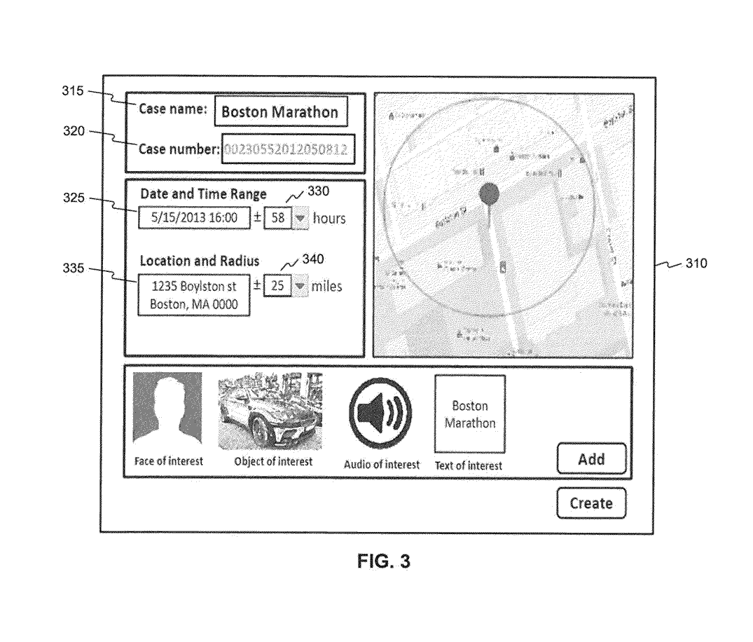

One example of a GUI that may be used by the investigator 150 to provide the target search parameter(s) is shown in FIG. 3. Referring for a moment to FIG. 3, the illustrated Create New Case GUI 310 of the multimedia processing engine 110 includes a case name text box 315 where a user (e.g., the investigator 150) may enter words that name the case; a case number text box 320 where a user may enter characters signifying a number for the case; a date and time text box 325 where a user may enter characters specifying a date and time that are used as or to formulate target search parameters; a time-frame pull-down menu 330 where a user may choose from the pull-down menu to specify a time range that is used as or to formulate target search parameters; a location text box 335 where a user may enter characters specifying a geographic location (e.g., an address or latitude and longitude) that is used as or to formulate target search parameters; and a search radius pull-down menu 340 where a user may choose from the pull-down menu to specify a geographic area that is used as or to formulate target search parameters.

As a use case example, consider where the investigator 150 inputs via the GUI 310 to the multimedia processing engine 110 target search parameters of a date of Apr. 15, 2013; a time range of 12:00 pm to 4:00 pm; a location of 700 Boylston Street, Boston, Mass.; a multimedia feature of “male wearing a white baseball cap” (not shown) and a crowd definition of “whitelisted” (not shown).

Referring again to FIG. 2, at stage 230, process 200 provides the target parameters to the crowd devices that are executing the data collection application 125. In some implementations, the target parameters may be passed to the data collection applications 125 in the form of search parameters, which the application uses to search for and identify specific, relevant multimedia items among all of the multimedia items contained on a crowd user's digital computing device. For example, in the case of system 100 shown in FIG. 1, the multimedia processing engine 110 may push, or the digital computing devices 130 of the crowd users may pull, the target parameters to the data collection application 125 in the form of search parameters, as represented by the arrow 112.

Process 200 of FIG. 2 next identifies multimedia items on the crowd devices that are fairly similar to, match, or otherwise correspond to the target parameters (stage 240). In various implementations, this stage may be carried out by the data collection application instances 125 running on the crowd devices, for example, by the digital computing devices 130 of the crowd users of FIG. 1.

Thus, continuing the previous use case example, a data collection application 125 running on a digital computing devices 130 may search through all of the multimedia items contained on the digital computing devices 130 and identify the subset of multimedia items that: 1) are time-stamped with a date of Apr. 15, 2013; 2) are time-stamped with a time that falls between 12:00 pm and 4:00 pm; 3) are location-stamped with geographic information (e.g. latitude and longitude) at or near 700 Boylston Street, Boston, Mass.; and 4) contain an image (still or video) that includes a male wearing a white baseball cap.

In this use case example, the target/search parameters also include a “crowd definition” parameter, which specifies which of the crowd users 130 can supply multimedia items to the multimedia processing engine 110. Here, the crowd definition parameter specifies “whitelisted” users, and the data collection application 125 running on a digital computing device 130 will verify that the user of the particular digital computing device 130 has been classified as a whitelisted user, for example by checking a classification flag that was uploaded to that digital computing device 130 by the multimedia processing engine 110.

At stage 250, process 200 receives the multimedia items on the crowd devices that were identified by the data collection application 125 as corresponding to the target parameters in stage 240. For example, in the example of system 100 shown in FIG. 1, the digital computing devices 130 may transmit the identified multimedia items to the multimedia processing engine 110, which receives them as represented by the arrow 114. In various embodiments, the digital computing devices 130 may also transmit metadata in association with each of the identified multimedia items, such as metadata describing the time, date, location, and features associated with each of the identified multimedia items.

And finally, at stage 260, process 200 displays the identified multimedia items in a date and/or location context. In various implementations, the multimedia processing engine 110 of FIG. 1 may perform this stage such that the investigator 150 can see the collected multimedia items that match the target parameters simultaneously with a representation of the date and/or location associated with each multimedia item. The multimedia processing engine 110 may arrange the context based on date and location metadata associated with and describing each of the identified multimedia items, which metadata may include crowd-sourced tags.

Continuing the previous use case example, to represent location context, the multimedia processing engine 110 may display a map of the area surrounding 700 Boylston Street, Boston, Mass. and show an icon or thumbnail image of each multimedia item (e.g., still image or video) that includes a male wearing a white baseball cap placed on the map according to its associated location information (e.g. latitude and longitude metadata). In some implementations, to represent time/date context, the multimedia processing engine 110 may display the associated date and time (e.g., from time-stamp metadata) in text under each icon or thumbnail image. In other implementations, the multimedia processing engine 110 may represent time/date context by providing controls that allow a user to specify and display a date and time range and by displaying only those multimedia items that fail within that specified date and time range. In such implementations, the multimedia items displayed on the map vary when the user varies the specified date and time range.

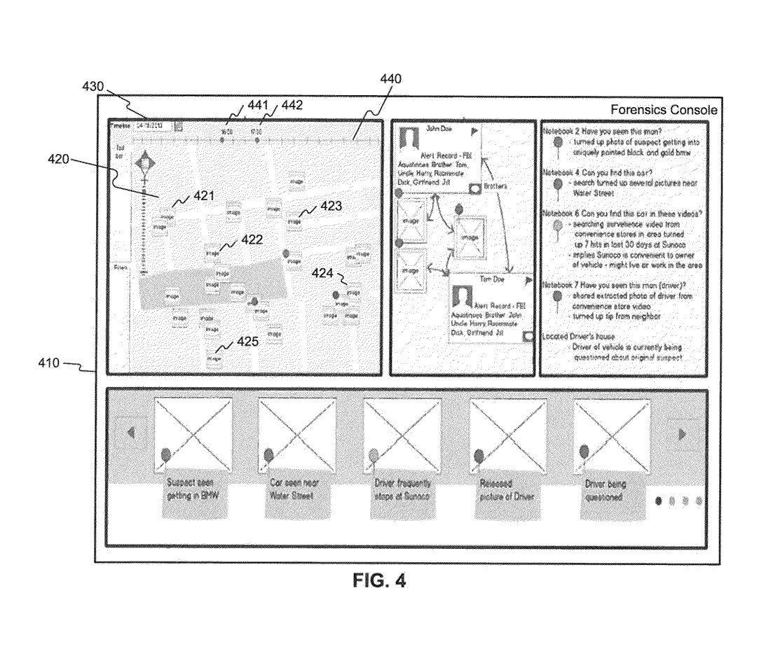

One example of a GUI that may be used to display the identified multimedia items in a date and/or location context is shown in FIG. 4. Referring for a moment to FIG. 4, the illustrated Forensics Console GUI 410 of the multimedia processing engine 110 includes a map 420 of the area surrounding a target location. In the implementation shown, icons representing multimedia items, such as icons 421-425, are superimposed on the map 420 at positions corresponding to the geographic location metadata associated with each of the multimedia items, which provides a viewer with location context for each multimedia item.

In the implementation shown, the GUI 410 also includes a selectable date display 430 and a timeline 440 that includes a user-variable beginning-time control 441 and a user variable ending-time control 442. These features provide a viewer with date/time context for each multimedia item, as their settings indicate the date and time range associated with the creation of each of the multimedia items whose icons (e.g., 421-425) are currently displayed on the map 420—for example, all the multimedia items represented by the icons shown on the map were created or time-stamped on Apr. 18, 2003 between the hours of 1600 and 1700 (4:00 pm and 5:00 pm). In this implementation, the multimedia item icons displayed on the map 420 would change if the user varies the date entered in the selectable date display 430 or varies the time range indicated by the beginning-time control 441 and the ending-time control 442.

Referring again to FIG. 2, the minutes and hours after an emergency or event are often the most critical, and implementations such as process 200 give intelligence and law enforcement investigators the ability to quickly and easily engage the crowd to contribute multimedia items relevant to an investigation. In a few minutes, an analyst may be able to open a new case, specify target parameters, and begin receiving new multimedia items from crowd-source electronic devices.

One of ordinary skill will recognize that process 200 is presented in a simple form for conciseness and clarity of explanation, and that stages may be added to, deleted from, reordered, or modified within process 200 without departing from the principles of this disclosure. For example, the multimedia processing engine 110 could receive all of the multimedia items contained on the digital computing devices 130, without any filtering or selection by the data collection application 125, and the multimedia processing engine 110 could perform stage 240 by itself. For another example, stage 210 may be modified to provide the data collection application not only to the devices of crowd users who voluntarily load the collection application, but also to devices belonging to people who do not volunteer, such as suspects who may have had their laptops, mobile phones, etc. captured or confiscated by legal authorities, and to infrastructure devices that cover a target location, such as traffic cameras, security cameras, ATM cameras, and the like. Many other variations are possible within the scope of this disclosure.

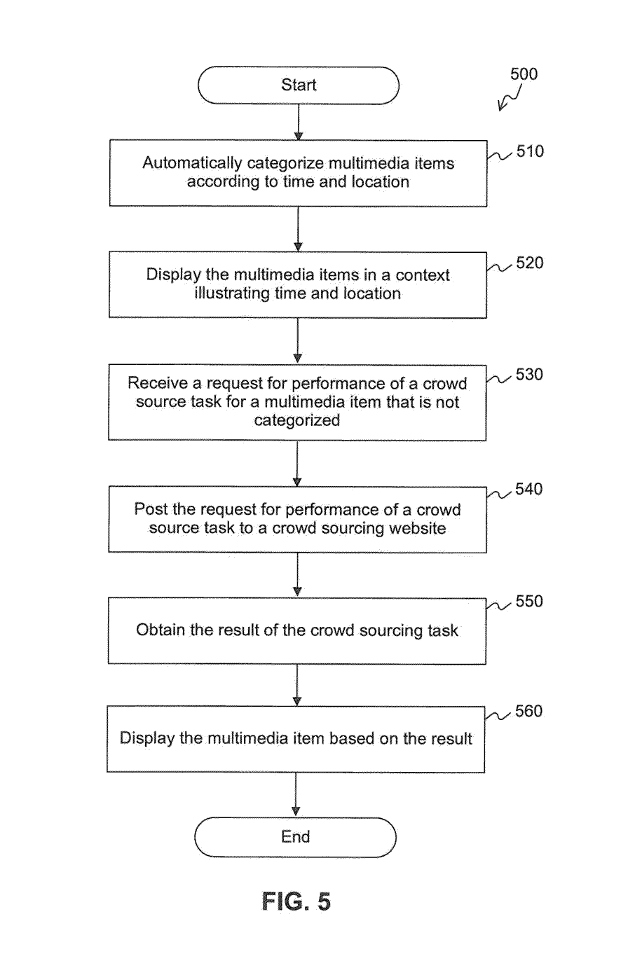

FIG. 5 is an example of a process 500 for processing a plurality of multimedia items, consistent with the principles of this disclosure. In some implementations, all or a portion of process 500 may be implemented in software (e.g., the multimedia processing engine 110 of FIG. 1) or firmware running on one or more computing systems, such as the computing system 105 of FIG. 1. As shown in FIG. 5, process 500 begins with automatically categorizing multimedia items according to time and location (stage 510). In various implementations, a software program, (e.g., the multimedia processing engine 110 of FIG. 1) may examine time-stamp metadata or other temporal data associated with each multimedia item and use it to sort, group, index, or otherwise temporally categorize each multimedia item. In some implementations, the time-stamp metadata may be created by the electronic device that created the multimedia item e.g., the digital computing devices 130) and contained in or associated with a multimedia item's file (e.g., a JPEG file). In various implementations, the software program, (e.g., the multimedia processing engine 110 of FIG. 1) may examine location-stamp metadata or other location data associated with each multimedia item and use it to sort, group, index, or otherwise spatially categorize each multimedia item. In some implementations, the location-stamp metadata may be created by the electronic device (e.g., a smart phone with GPS capability as one of the digital computing devices 130) that created the multimedia item and contained in or associated with a multimedia item's file (e.g., a JPEG file). In various implementations, the software program, (e.g., the multimedia processing engine 110 of FIG. 1) may also, or alternatively, examine a human-applied tag(s) describing time and/or location associated with each multimedia item and use the tags) to sort, group, index, or otherwise temporally and/or spatially categorize each multimedia item. In such implementations, the tags may be considered another sort of metadata.

At stage 520, process 500 displays the multimedia items in a context illustrating or indicating time and location. In various implementations, the multimedia processing engine 110 of FIG. 1 may employ a GUI rendered on a display device (not shown) to display the multimedia items. In some embodiments, to represent location context, stage 520 may display a map of an area that encompasses at least a portion and preferably all) of the locations associated with the multimedia items, and may display a depiction of each multimedia item (e.g., an icon, a thumbnail image, etc.) on the map according to its associated location information (e.g. latitude and longitude metadata). To represent time context, which may include date, stage 520 may display the associated date and time (e.g., from time-stamp metadata) in text under each depiction of each multimedia item, or may display next to the map a timeline that indicates the time period of the currently displayed depiction of each multimedia item. An example of a GUI 410 that may be employed by stage 520 is shown in FIG. 4, which was described above.

At stage 530 of FIG. 5, process 500 receives a request for performance of a crowd source task related to a multimedia item that has a feature(s), trait(s), or characteristic(s) that is not categorized, or that is not categorized in a satisfactory manner—for instance, in a manner as desired by a user (e.g., the investigator 150) or in a manner that is sufficiently specific or narrow. For example, a multimedia item may be categorized with respect to time and location, but a user may desire it to be categorized for some other characteristic or feature, such as content e.g. whether or not a photo shows a certain object or word, whether an audio file contains a specific sound, etc. For another example, a multimedia item may be categorized with respect to content feature, such as images showing a male, but may not be categorized with further specificity or narrowness—e.g. images showing a male that is Caucasian, or images showing a male wearing a white cap. In some implementations, the request for performance of a crowd source task may be received, for example, from a user, such as the investigator 150 of FIG. 1, who may input the request using a user interface (e.g., a GUI) to the multimedia processing engine 110. In some embodiments, a crowd source task may be represented using a “notebook,” as described in the incorporated-by-reference U.S. Provisional Application No. 61/870,402. In various implementations, the request for performance of a crowd source task related to a multimedia item may be initiated by a user, such as the investigator 150, who desires that a group of multimedia items be categorized further, or categorized in a new or different way, in order to be helpful in achieving the user's objectives.

For example, consider the use case where the investigator 150 has a goal or objective to identify possible suspects in the Boston Marathon bombings, and the system 100 has already collected several thousand digital photos of the bombing location, which have been categorized according to time and location. When the investigator 150 learns that the bombs may have been concealed in backpacks, he desires to study the subset of photos among the several thousand photos that show a backpack. But in this example, the photos are not categorized or classified to indicate the subset that shows a backpack, and consequently the investigator 150 cannot search or sort the photos to produce the subset having the characteristic he desires. Because personally reviewing several thousand photos and appropriately tagging those photos showing a backpack would be too time consuming, the investigator 150 instead may use the system 100 to request a crowd source task to perform the desired categorization. Because the crowd may be composed of a large number of people who split and share the work, the crowd can classify the several thousand photos into “contains a backpack” and “does not contain a backpack” categories in a relatively short amount of time.

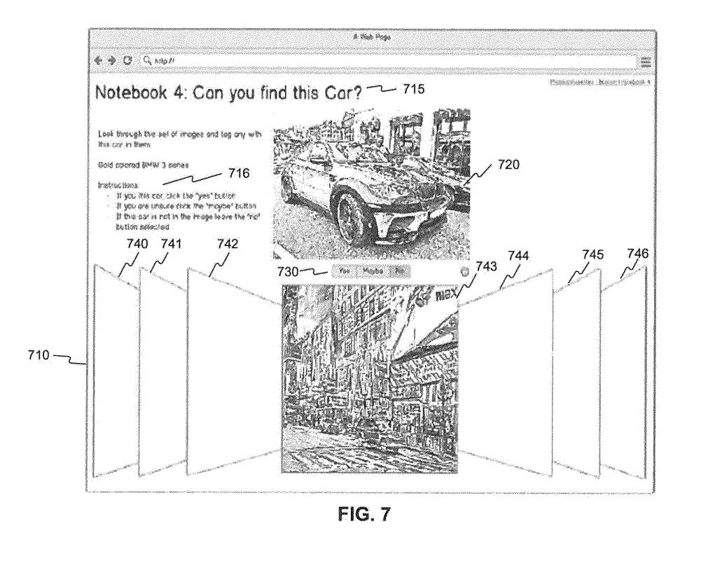

At stage 540 of FIG. 5, process 500 posts the request for performance of a crowd source task to a crowd sourcing website. For an example with respect to FIG. 1, the multimedia processing engine 110 may provide the crowd source task to the website server 145, as represented by the arrow 117. Crowd users 140 may access and interact with the website server 145 using webpage(s) served by the website server 145 that enable the crowd users 140 to view and perform the crowd source task and thereby produce a result. An example of a webpage for a crowd source task is shown in FIG. 7, which is described below.

Continuing the previous use case example with respect to stage 540, the multimedia processing engine 110 may provide the crowd source task to the website server 145, where the task is specified as classifying photos into two categories: “contains a backpack” and “does not contain a backpack,” In this example, the website server 145 may separate the overall body of photos into smaller groups (e.g. 15-50 photos) and sequentially display photos from each group of photos to each crowd user of the crowd users 140, prompt them with a simple, objective, categorization question, such as “Is there a backpack in this photo?” and provide controls for them to provide an answer, such as a radio button for “yes” and a radio button for “no.” The website server 145 may then tag earth photo with metadata reflecting the answer—in this case, indicating whether or not each photo depicts a backpack.

At stage 550 of FIG. 5, process 500 obtains the result of the crowd source task. For example, as shown in FIG. 1, the website server 145 may transmit the result to the multimedia processing engine (arrow 118), Continuing the use case example above, the result may be one or more photos that are each tagged with metadata indicating whether or not the photo depicts a backpack, and the multimedia processing engine 110 may obtain the one or more tagged or categorized photos by uploading or otherwise receiving them from the website server 145.

Finally, at stage 560 of FIG. 5, process 500 displays the multimedia item having the characteristic(s) that was previously not categorized, based on the result. In some implementations, stage 560 may employ the GUI 410 shown in FIG. 4 to display the multimedia item based on the result. Finishing the use case example above, the multimedia processing engine 110 may display only the photos that depict a backpack, based on the tagging metadata provided by the crowd users 140 via the website server 145.

One of ordinary skill will recognize that process 500 is presented in a simple form for conciseness and clarity of explanation, and that stages may be added to, deleted from, reordered, or modified within process 500 without departing from the principles of this disclosure. For example, stage 540 could be modified to eliminate the use of a crowd sourcing website, and replaced with operations that provide the crowd source task directly to the crowd (e.g., crowd users 140); for example by entailing the crowd source task to the members of the crowd.

For another example, stages may be added to process 500 to have a crowd verify the result provided by the first crowd. For instance, the one or more photos that are each tagged with metadata indicating whether or not the photo depicts a backpack may be provided to a new crowd to review and to tag using true/false questions that are based on the tags provided by the first crowd. Thus, a reviewer from the new crowd may be shown a photo that was previously tagged as “depicts a backpack” and prompted to characterize as true or false the statement “This photo shows a backpack,” Similarly, the reviewer from the new crowd may be shown a photo that was previously tagged as “does not depict a backpack” and prompted to characterize as true or false the statement “This photo does not show a backpack.” In various implementations, the results of this may be that all photos garnering “true” answers are further categorized as verified and are used in the display to the investigator 150, and all photos garnering “false” answers are further categorized as unverified and are not used in the display to the investigator 150. Further to this example, additional stages may be added to the process 500 to rank specific crowd users in relation to other crowd users according to how many of their answers are verified, and to reward crowd users if their ranking surpasses a predefined threshold, such as 95% verified answers or having a verified percentage in the top 20% of all ranked users. The reward may take almost any form, including, for example, a public display of a crowd user's top ranking or a share of reward money offered in connection with solving a crime. Many other variations to process 500 are possible within the scope of this disclosure.

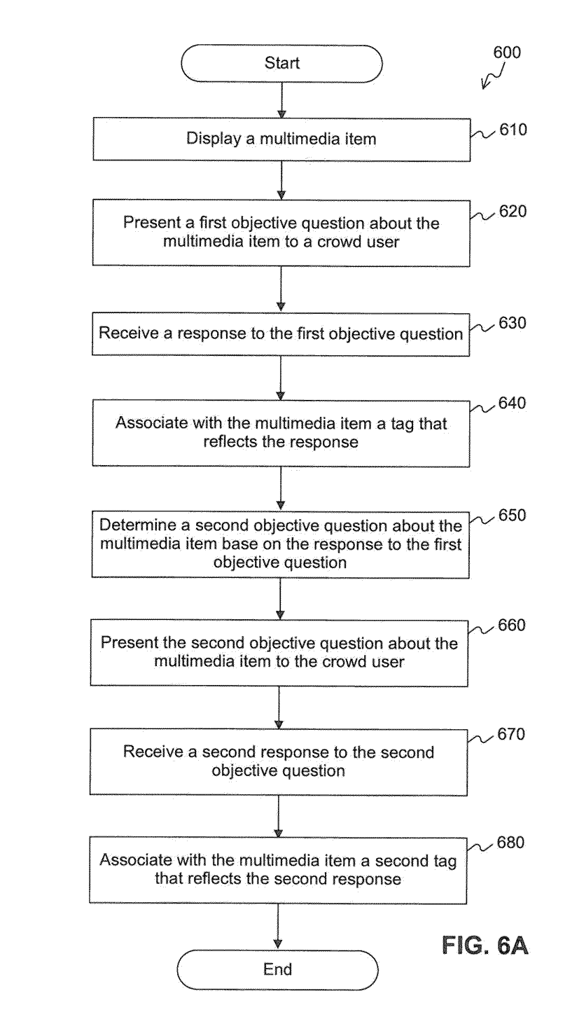

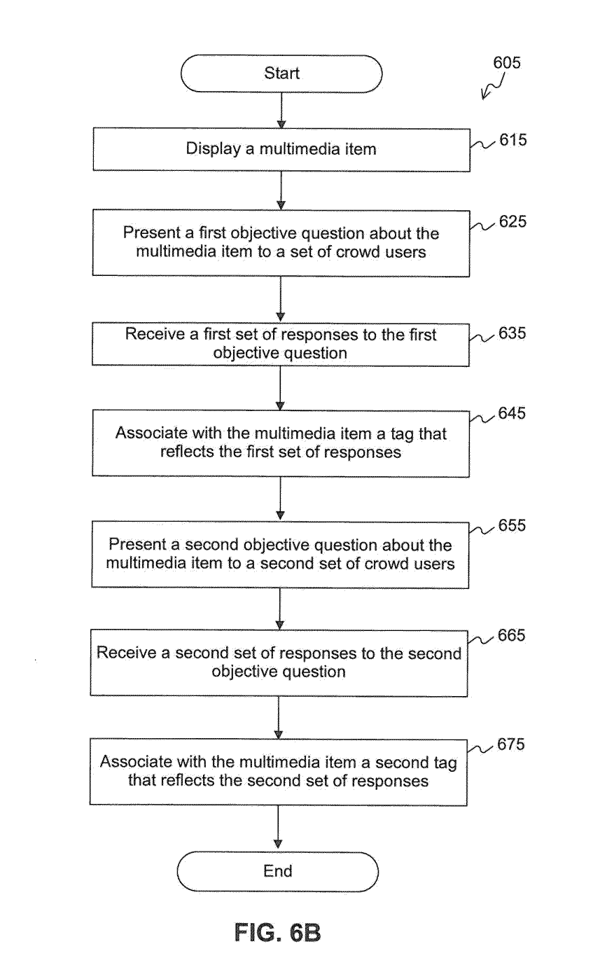

FIG. 6A is an example of a process 600 for processing a multimedia item, consistent with the principles of this disclosure. In some implementations, all or a portion of process 600 may be implemented in software or firmware running on one or more computing systems, such as the website server 145 of FIG. 1. In some variants, process 600 may implement a crowd source task as described above with respect to FIGS. 1 and 5. As shown in FIG. 6A, process 600 begins by displaying a multimedia item (stage 610). In various implementations described in this disclosure, the term “displaying” may be used to refer to audio presentation as well as visible presentation. In such implementations, if the multimedia item is an audio recording (or a video recording that includes audio), then the audio recording may be audible rendered such that a user can hear it and this may be considered to be a form of displaying as used in this disclosure.

At stage 620, the process 600 presents a first objective question about the multimedia item to a crowd user. In various implementations, an objective question is a factual question that most people can easily answer using little or none of their personal opinion. One form of an objective question asks about the existence or nonexistence of an observable, discernable, or perceptible feature or characteristic e.g., an object, sound, word, or the like, Examples of objective questions include “does this photo contain a male?” “does this video contain a red car?” “does this photo contain the word ‘Boston’?” and “Is the person speaking in this audio recording a female?” Another example of objective questions includes questions that ask for a comparison of one object with another, such as “does the car shown in photo A appear in photo B?” An example of a non-objective question is a question that asks for the identification of a person in an open-ended manner, such as “who is the man in this photo?”

At stage 630, the process 600 receives a response to the first objective question of stage 620. In some implementations, process 600 may limit the response that a user is able to supply to binary choices, such as “yes” or “no” and “true” or “false;” or to tertiary choices that add “do not know” or the like to the binary choices.

Consider, as an example of an objective question, a use case where the website server 145 of FIG. 1 provides a webpage to the crowd users 140 that displays a photo of a car labeled “A” next to a photo containing several cars and labeled “B.” The webpage also displays the objective question “Does the car shown in photo A appear in photo B?” and provides radio control buttons that allow a crowd user to provide one of three responses: “yes,” “no,” or “maybe.” In this example, the photo labeled “B” is the multimedia item referenced in stages 610 and 620.

One example of a webpage that may be used to implement process 600 is shown in FIG. 7. Referring fir a moment to FIG. 7, the illustrated webpage 710 may guide crowd users 140 to perform a crowd source task for categorizing, classifying, or otherwise describing a set of photo multimedia items 740-746 guided by structured objective question(s), which is one example of a crowd source task as described above with respect to FIGS. 1 and 5, As shown, the webpage 710 includes an example of an objective question 715 that asks “Can you find this car?” as shown in photo 720 in any of the photos 740-746. The webpage 710 allows the user to circulate through the photos 740-746 one at a time, and for each one, indicate whether or not he car shown in the photo 720 appears in the photo currently under consideration.

As shown in FIG. 7, the webpage 710 is currently displaying the photo 743 to the user. The instructions 716 direct the user to activate one of the radio button controls 730 to indicate either: 1) the car appears in the photo 743 by clicking the “yes” button; 2) the user is unsure whether the car appears in the photo 743 by clicking the “maybe” button; or 3) the car does not appear in the photo 743 by clicking the “no” button. The button activated indicates the user's response to the objective question 715.

Referring again to FIG. 6A, at stage 640, the process 600 associates with the multimedia item a tag (e.g., metadata) that reflects the response. Continuing the previous use case, if the crowd user 140 answered “yes,” then stage 640 will tag the photo labeled “B” with information indicating that photo “B” contains car “A.” If the crowd user 140 answered “no,” then stage 640 will tag the photo labeled “B” with information indicating that photo “B” does not contain car “A.” Or, if the crowd user 140 answered “maybe,” then stage 640 will tag the photo labeled “B” with information indicating that photo “B” may contain car “A.” In various implementations, the tag may be a separate file that is associated with the multimedia item (e.g., via database links or indices), or the tag may be added into or appended onto the file containing the multimedia item (e.g., a JPEG file, an MPEG file, a WMA file, etc.).

At stage 650, the process 600 chooses, selects, or otherwise determines a second objective question about the multimedia item, where the second objective question is determined based on the response to the first objective question, as received in stage 630. Thus, in this implementation the second objective question will vary depending on the response to the first objective question, and the crowd user experiences a structured set of questions that classify each multimedia item into categories that are useful to and desired by a user, such as the investigator 150.

Continuing with examples based in the previous use case, if the crowd user 140 responded “yes” to the first objective question, indicating that the car shown in photo A appears in photo B, then stage 650 may select another objective question related to the car in photo B, such as “Is there a driver in the car?” On the other hand, if the crowd user 140 responded “no” to indicate that the car shown in photo A does not appear in photo B, then stage 650 may decide on or determine an objective question that is unrelated to the car, but which is seeks information needed or desired for analysis, such as “Is there a backpack in this photo?”

At stage 660, the process 600 presents the second objective question, which was determined in stage 650, to the crowd user. Next, the process 600 receives a response to the second objective question from the crowd user (stage 670). These two stages may be implemented in a manner similar to that described above with respect to stages 620 and 630.

Finally, at stage 680, the process 600 associates with the multimedia item a second tag (e.g., metadata) that reflects the second response. This stage tray be implemented in a manner similar to that described above with respect to stage 640.

One of ordinary skill will recognize that process 600 is presented in a simple form for conciseness and clarity of explanation, and that stages may be added to deleted front, reordered, or modified within process 600 without departing from the principles of this disclosure. For example, additional stages similar to stages 650-680 may be added after stage 680 to add additional tags to the multimedia data by presenting additional questions in a structured fashion. For another example, stages may be added to verify a crowd user's answers and/or to rank a crowd user's work, in a manner similar to that described above with respect to process 500 of FIG. 5, For yet another example, stages may be added to specify a specific subset of crowd users among the universe of crowd users 140 that are allowed to interact with the process 600, in a manner similar to that described above with respect to process 200 of FIG. 2. Many other variations to process 600 are possible within the scope of this disclosure.

FIG. 6B is an example of a process 605 for processing a multimedia item, consistent with the principles of this disclosure. In some implementations, all or a portion of process 605 may be implemented in software or firmware running on one or more computing systems, such as the website server 145 of FIG. 1. In some variants, process 605 may implement a crowd source task as described above with respect to FIGS. 1 and 5. As shown in FIG. 6B, process 605 begins by displaying a multimedia item (stage 615). In various implementations, such as those in which process 605 is implemented as a web service, webpage, or other application accessible by many crowd users, process 605 may interact with many crowd users, either serially, or in parallel, or a combination of the two. In such implementations, the multimedia item may be displayed to more than one crowd user, and the crowd users may be placed into sets and processed as sets of crowd users.

At stage 625, the process 605 presents a first objective question about the multimedia item to a set of crowd users. In various implementations, an objective question may be a factual question that most people can easily answer using little or none of their personal opinion, as explained above with respect to FIG. 6A.

At stage 635, the process 605 receives a first set of response to the first objective question of stage 625 from the set of crowd users. In some implementations, process 605 may limit the response that an individual user is able to supply to binary choices, such as “yes” or “no” and “true” or “false;” or to tertiary choices that add “do not know,” “maybe” or the like to the binary choices, as explained above with respect to FIG. 6A. One example of a webpage that may be used to implement process 605 is shown in FIG. 7, which is described above.

As shown in FIG. 6B, at stage 645, the process 605 associates with the multimedia item a tag (e.g., metadata) that reflects the first set of responses. In some implementations, the tag may indicate how a majority of the users in the set of crowd users answered the first objective question of stage 625. For a use case example, if the set of crowd users includes 100 users, and the objective question asks “Is the person in this photo a male?” and 70 users from the set of crowd users answered “yes” and 30 users answered “no,” then process 605 may create or set a tag to indicate that the multimedia item (i.e., the photo in this example) contains a male, and associate the tag with the multimedia item.

In various implementations, the process 605 may use techniques other than majority to tag a multimedia item, such as a weighted majority technique where the answers of some users count more than others or techniques that account for tertiary responses where an answer such as “maybe” is accounted for in various ways—for example, by counting a “maybe” the same as a “no,” or by counting a “maybe” as one-half of a “yes.”

At stage 655, the process 605 presents a second objective question to a second set of crowd users. In various implementations, the second set of crowd users contains different individuals than the first set of crowd users. In various implementations, the second objective question may be different than the first objective question. In some such implementations, the second questions may relate to the same or similar subject matter, object, or item as the first question. Continuing the previous use case example, the second objective question may ask “Is the person in this photo wearing a white hat?” This example of second question is related to the same object as the first objective question—the person—but asks about a different characteristic a white hat versus being a male.

Next, the process 605 receives a second set of responses to the second objective question from the second set of crowd users (stage 665). This stage may be implemented in a manner similar to that described above with respect to stage 635.

Finally, at stage 675, the process 605 associates with the multimedia item a second tag (e.g., metadata) that reflects the second set of responses. This stage may be implemented in a manner similar to that described above with respect to stage 645.

One of ordinary skill will recognize that process 605 is presented in a simple form for conciseness and clarity of explanation, and that stages may be added to, deleted from, reordered, or modified within process 605 without departing from the principles of this disclosure. For example, additional stages similar to stages 655-675 may be added after stage 675 to add additional tags to the multimedia data by presenting additional questions additional sets of crowd users, such as asking a third set of crowd users “Does the person in this photo have curly hair?” For another example, the first tag and the second tag may be combined into a single tag that describes multiple characteristics of the multimedia item. For still another example, stages may be added to verify an individual crowd user's answers or a set of crowd users' answers and/or to rank an individual crowd user's work or a set of crowd users' work, in a manner similar to that described above with respect to process 500 of FIG. 5. For yet another example, stages may be added to specify a specific subset of crowd users among the universe of crowd users 140 that are allowed to interact with the process 605, in a manner similar to that described above with respect to process 200 of FIG. 2. Many other variations to process 605 are possible within the scope of this disclosure.

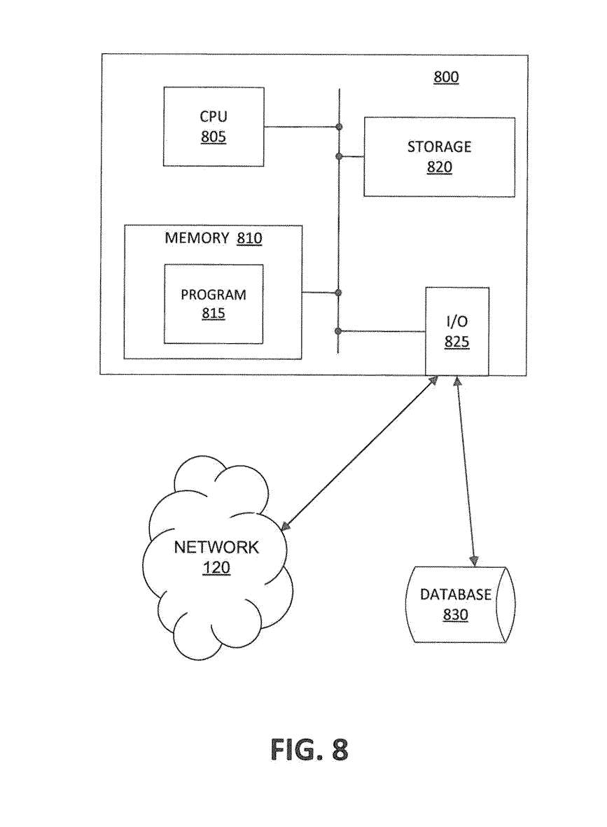

FIG. 8 is a block diagram of an example of a computing system or data processing system 800 that may be used to implement embodiments consistent with this disclosure. Other components and/or arrangements may also be used. In some embodiments, computing system 800 may be used to implement, either partially or fully, various components of FIG. 1, such as the multimedia processing engine 110 and the website server 145. In some embodiments, computing system 800 may be used to implement, either partially or fully, process 200 of FIG. 2, process 500 of FIG. 5 and processes 600 and 605 of FIGS. 6A and 6B, among other things.

Computing system 800 includes a number of components, such as a central processing unit (CPU) 805, a memory 810, an input/output (I/O) device(s) 825, and a nonvolatile storage device 820. System 800 can be implemented in various ways. For example, an implementation as an integrated platform (such as a server, workstation, personal computer, laptop, smart phone, etc.) may comprise CPU 805, memory 810, nonvolatile storage 820, and I/O devices 825. In such a configuration, components 805, 810, 820, and 825 may connect and communicate through a local data bus and may access a database 830 (implemented, for example, as a separate database system) via an external I/O connection. I/O component(s) 825 may connect to external devices through a direct communication link (e.g., a hardwired or local will connection), through a network, such as a local area network (LAN) or a wide area network (WAN), and/or through other suitable connections. System 800 may be standalone or it may be a subsystem of a larger system.

CPU 805 may be one or more known processors or processing devices, such as a microprocessor from the Core™ i7 family manufactured by the Intel™ Corporation of Santa Clara, Calif. or a microprocessor from the FX™ family manufactured by the AMD™ Corporation of Sunnyvale, Calif. Memory 810 may be one or more fast storage devices configured to store instructions and information used by CPU 805 to perform certain operations, functions, methods, and processes related to embodiments of the present disclosure. Storage 820 may be a volatile or non-volatile magnetic, semiconductor, tape, optical, or other type of storage device or computer-readable medium, including devices such as CDs and DVDs, meant for long-term storage.

In the illustrated embodiment, memory 810 contains one or more programs or subprograms 815 loaded from storage 820 or from a remote system (not shown) that, when executed by CPU 805, perform various operations, procedures, processes or methods cons stent with the present disclosure. Alternatively, CPU 805 may execute one or more programs located remotely from system 800. For example, system 800 may access one or more remote programs via network 120 that, when executed, perform functions and processes related to embodiments of the resent disclosure.

In one embodiment, memory 810 may include a program(s) 815 for a multimedia processing engine 110. In another embodiment, memory 810 may include a program 815 that implements at least a portion of process 200 of FIG. 2, process 500 of FIG. 5, or processes 600 and 605 of FIGS. 6A and 6B. In yet another embodiment, memory 810 may include a program 815 that implements at least a portion of the functionality of the website server 145 as described with respect to FIG. 1. In some embodiments, memory 810 may also include other programs, applications, or data that implement other methods and processes that provide ancillary functionality. For example, memory 810 may include programs or data used to generate a GUI, which may generate interactive displays as depicted in FIG. 3, 4, or 7.

Memory 810 may be also be configured with other programs (not shown) unrelated to this disclosure and/or an operating system (not shown) that performs several functions well known in the art when executed by CPU 805, By way of example, the operating system may be Microsoft Windows™, Unix™, Linux™, an Apple Computers™ operating system, Personal Digital Assistant operating system such as Microsoft CE™, or other operating system. The choice of operating system, and even to the use of an operating system, is not critical to this disclosure.

I/O device(s) 825 may comprise one or more input/output devices that allow data to be received and/or transmitted by system 800. For example, I/O device(s) 825 may include one or more input devices, such as a keyboard, touch screen, mouse, and the like, that enable data to be input from a user. Further, I/O device(s) 525 may include one or more output devices, such as a display screen, CRT monitor, LCD monitor, plasma display, printer, speaker devices, and the like, that enable data to be output, displayed, or otherwise presented to a user. I/O device(s) 825 may also include one or more digital and/or analog communication input/output devices that allow computing system 800 to communicate, for example, digitally, with other machines and devices. Other configurations and/or numbers of input and/or output devices may be incorporated in I/O device(s) 825.

In the embodiment shown, system 800 is connected to a network 120 (such as the Internet, a private network, a virtual private network, a cellular network, or other network), which may in turn be connected to various systems and computing machines (not shown), such as servers, personal computers, laptop computers, client devices (e.g., digital computing devices 130 or the computers of the crowd users 140), etc. in general, system 800 may input data from external machines and devices and output data to external machines and devices via the network 120.

In the example of an embodiment shown in FIG. 8, database 830 is a standalone database external to system 800. In other embodiments, database 830 may be hosted by system 800. In various embodiments, database 830 may manage and store data used to implement systems and methods consistent with this disclosure. For example, database 830 may manage and store multimedia item files, user tags and metadata, indexing information, and the like.

Database 830 may comprise one or more databases that store information and are accessed and/or managed through system 800. By way of example, database 830 may be a noSQL database, an Oracle™ database, a Sybase™ database, or some other database. Systems and methods consistent with this disclosure, however, are not limited to separate data structures or databases, or even to the use of a formal database or data structure.

One of ordinary skill will recognize that the components and implementation details of the system in FIG. 8 are examples presented for conciseness and clarity of explanation. Other components and implementation details may be used. For example, the computing system 800 may be used to implements some components of the exemplary architecture described in the incorporated-by-reference U.S. Provisional Application No. 61/870,402.

Other embodiments of the invention will be apparent to those skilled in the art from consideration of the specification and practice of the invention disclosed herein. It is intended that the specification and examples be considered as exemplary only, with a true scope and spirit of the invention being indicated by the claims below.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method, implemented using a computing system, for collecting multimedia items, the method comprising:
receiving, by the computing system, a set of search parameters;
providing, by the computing system, the set of search parameters to a plurality of copies of a collection application on a plurality of digital devices;
receiving, by the computing system and from the plurality of copies of the collection application executing on the plurality of digital devices, multimedia items that were created by the plurality of digital devices and that correspond to the set of search parameters; and
displaying the multimedia items.

2. The method of claim 1, further comprising:
providing the plurality of copies of the collection application to the plurality of digital devices.

3. The method of claim 1, wherein the set of search parameters includes a target date; and
wherein the receiving multimedia items comprises:
receiving, by the computing system and from the plurality of copies of the collection application executing on the plurality of digital devices, multimedia items that were created by the plurality of digital devices on a date corresponding to the target date; and
wherein the displaying comprises:
displaying the multimedia items in a date context.

4. The method of claim 3, wherein the target date comprises a range of dates.

5. The method of claim 1, wherein the set of search parameters includes a target location; and
wherein the receiving multimedia items comprises:
receiving, by the computing system and from the plurality of copies of the collection application executing on the plurality of digital devices, multimedia items that were created by the plurality of digital devices at a location corresponding to the target location; and
wherein the displaying comprises:
displaying the multimedia items in a location context.

6. The method of claim 5, wherein the target location comprises an area that includes the target location.

7. The method of claim 3, wherein the set of search parameters includes a target time; and
wherein the receiving multimedia items comprises:
receiving, by the computing system and from the plurality of copies of the collection application executing on the plurality of digital devices, multimedia items that were created by the plurality of digital devices on a date corresponding to the target date and at a time corresponding to the target time; and
wherein the displaying comprises:
displaying the multimedia items in a date and time context.

8. The method of claim 7, wherein the target time comprises a range of times.

9. The method of claim 1, wherein the set of search parameters includes a crowd definition; and
wherein the receiving comprises:
receiving, by the computing system, multimedia items that were created by a subset of the plurality of digital devices that corresponds to the crowd definition.

10. The method of claim 9, wherein the crowd definition specifies at least one of a group of definitions consisting of employees of an organization; the general public; people located within a specified geographic area and people that have demonstrated an ability to accurately answer objective questions about multimedia items.

11. The method of claim 1, wherein the set of search parameters includes a target image feature; and
wherein the receiving multimedia items comprises:
receiving, by the computing system and from the plurality of copies of the collection application executing on the plurality of digital devices, multimedia items containing an image corresponding to the target image feature.

12. A method, implemented using a computing system having a display device, for processing a plurality of multimedia items, the method comprising:
automatically categorizing the plurality of multimedia items according to time and location;
displaying within a graphical user interface of a computer application, on the display device for viewing by a user, the plurality of multimedia items in a context illustrating time and location;
receiving, via an input interface provided by the computer application, an input representative of a request for performance of a crowd source task related to a characteristic of a multimedia item that is not categorized;
posting the request for performance of the crowd source task to a user interface, wherein the crowd source task is performed by a crowd using the user interface to produce a result related to categorizing the characteristic of the multimedia item;
obtaining the result of the crowd source task; and
displaying, on the display device, the multimedia item based on the result.

13. The method of claim 12, further comprising:
posting the result of the crowd source task to a user interface with a second crowd source task to verify the result; and
obtaining a second result of the second crowd source task.

14. The method of claim 12, wherein obtaining the result of the crowd source task comprises;
obtaining one or more descriptive tag describing the multimedia item, wherein the one or more descriptive tag is supplied by the crowd.

15. The method of claim 14, wherein the multimedia item is a still image.

16. The method of claim 14, wherein the multimedia item is a video.

17. A method, implemented using a computing system, for processing a multimedia item, the method comprising:
displaying the multimedia item via a graphical user interface of a computer application executing on the computing system for viewing by a first crowd user;
presenting, via a graphical user interface, a first objective question about the multimedia item to the first crowd user;
receiving a first response to the first objective question;
associating, by the computer application executing on the computing system, a first descriptive tag reflecting the first response with the multimedia item;
determining, by the computer application executing on the computing system, a second objective question about the multimedia item based on the first response;
presenting, via the graphical user interface, the second objective question about the multimedia item to the first crowd user;
receiving a second response to the second objective question; and
associating, by the computer application executing on the computing system, a second descriptive tag reflecting the second response with the multimedia item.

18. The method of claim 17, wherein the second objective question narrows the subject matter of the first objective question.

19. The method of claim 17, further comprising;
receiving, by the computer application, a crowd definition; and
selecting the first crowd user according to the crowd definition.

20. The method of claim 19, wherein the crowd definition specifies at least one of a group of definitions consisting of employees of an organization: the general public, people located within a specified geographic area; and people that have demonstrated an ability to accurately answer objective questions about multimedia items.

21. The method of claim 17, further comprising;
displaying the multimedia item via the graphical user interface for viewing by a second crowd user;
presenting, via a graphical user interface, a question to the second crowd user that verifies the first response to the first objective question by the first crowd user;
receiving, from the second crowd user, a third response to the question that verifies the first response;
associating an evaluation tag with the first crowd user based on the third response;
wherein the evaluation tag reflects the ability of the first crowd user to accurately answer objective questions.

22. The method of claim 21, further comprising:
ranking the first crowd user in relation to other crowd users according to the evaluation tag; and
rewarding the first crowd user when the ranking surpasses a predefined threshold.

23. A method, implemented using a computing system, for processing a multimedia item, the method comprising;
displaying the multimedia item via a graphical user interface of a computer application executing on the computing system for viewing by a first set of crowd users and a second set of crowd users;
presenting, via the graphical user interface, a first objective question about the multimedia item to the first set of crowd users;
receiving a first set of responses to the first objective question;
associating, by the computer application executing on the computing system, a first descriptive tag reflecting the first set of responses with the multimedia item;
presenting, via the graphical user interface, a second objective question about the multimedia item to the second set of crowd users;
receiving a second set of responses to the second objective question; and
associating, by the computer application executing on the computing system, a second descriptive tag reflecting the second set of responses with the multimedia item.

24. The method of claim 23, wherein the first objective question pertains to a first characteristic of the multimedia item, and the second objective question pertains to a second characteristic of the multimedia item.
